(19) United States
(12) Patent Application Publication
(10) Pub. No.: US 2009/0202971 A1
(43) Pub. Date: Aug. 13, 2009

(54) On Track-Teaching

(76) Inventor: Eva Cortez, San Francisco, CA (US)

Correspondence Address: John Bargero, P.O BOX 471857, SAN FRANCISCO, CA, 94123, US

(21) Appl. No.: 12/368,279

(22) Filed: Feb. 9, 2009

Related U.S. Application Data
(60) Provisional application No. 61/063,859, filed on Feb. 7, 2008.

(51) Int. Cl. G09B 7/00; G09B 19/00

(52) U.S. Cl. 434/350; 434/188

(57) ABSTRACT

An interactive learning and behavioral modification system that utilizes computer hardware and software to create a learning scheme that is portable, individualized, and adjusts to each student. The system analyzes and manipulates the answers or data supplied by the students by a variety of means and then generates a new set of questions or tasks based on the individual student's performance. Problem difficulty is based on the student's performance and is increased or new material is introduced when a predetermined proficiency level has been attained. Furthermore, the data that is gathered from the students' replies is compiled and utilized as a tool to determine the effectiveness of the teacher allowing him or her to modify their teaching methods and improve on deficiencies. This allows the teacher to not only monitor the students' progress, but also their own.

### PRIORITY FILING

This application is claiming the filing date of Feb. 7, 2008 of provisional patent application Ser. No. 61/063859.

### FIELD OF THE INVENTION

The invention relates to an educational system or method that utilizes computer technology to assist instructors in educating students in a more efficient and productive manner, as well as providing necessary feedback to help the instructors become more effective.

### BACKGROUND OF THE INVENTION

Student performance has been declining in recent years. These students will be our future leaders and educating them needs a major correction factor. Our inability to produce well educated doctors, nurses, and engineers has led to outsourcing, where we need to look outside our country to address our labor force needs. We overlook our own able bodies, because we failed to teach them the skill sets they need to create an in-house work force across industries.

While we scramble to find out how to correct the educational problems, we direct our efforts on the teachers. Mandating new requirement subject exams and retraining them to new higher standard of re-training workshops put more emphasis in the wrong place. The time a student receives in front of a teacher can be one hour a day out of twenty four, yet our expectations what should take place in that hour are enormous. As we replace our workforce with skilled foreigners, we receive the English as a second language issues in our schools. Because of the prescription of pharmaceuticals drugs are at an all time high, our clinical trials are slowly revealing the brain cognitive impairments of ADD, Autism and the developmental challenged issues will eventually require some special education from the educational system. Giving the teacher greater challenges, and expecting greater demands makes one exhausted teacher.

Shifting the burden from the teacher to technology to meet the educational challenges of scanning, correcting, grading, scoring, maintaining a database and flagging special needs is desirable.

Parental involvement in the student's education is also an issue, in this busy world of single parent homes, or homes where both parents work there is a reduced involvement in their children's education. It is desirable that the parents become involved outside the classroom to create a change in their household environment where the child exposure is greater than the one hour spent in a classroom with the teacher. This parental involvement will aid in the education of students.

### SUMMARY OF THE INVENTION

With the previous in mind, it is an object of this invention to provide an educational system or method that utilizes computer hardware and software to create a learning scheme that is portable, individualized, and adjusts to each student. The system analyzes and manipulates the answers or data supplied by the students by a variety of means and then generates a new set of questions or tasks based on the individual student's performance. Problem difficulty is based on the student's performance and is increased or new material is introduced when a predetermined proficiency level has been attained. Furthermore, the data that is gathered from the students' replies is compiled and utilized as a tool to determine the effectiveness of the teacher allowing him or her to modify their teaching methods and improve on deficiencies. This allows the teacher to not only monitor the students' progress, but also their own.

The information gathered helps standardize the educational process. Standardization, creating a standard for all students, will help meet the higher standard of education needed today. Instead of placement testing, all that is needed is to look at the statistics from this system. The data reports statistically indicate how many math courses and at which level of math a university should plan for years in advance. This could replace the need for placement tests. By standardizing the 12 grader outcome we can make sure all freshman first year college students are competing on the same level playing field with the same skill set that they need to succeed.

It is apparent that measuring student attendance alone does not ensure quality education it should be based on actual performance. This system is able to determine the student's performance by statistical measurements on a weekly basis in real time. National testing and testing criteria controversy is no longer an issue of how to measure the quality of our education. There is of national importance to establish a form of standardization where all schools and states are operating to meet the requirements of creating a literate society. Identifying that standard, making sure that each campus recognizes those guidelines, and are measured by meeting those guidelines independent of economics, location, and district regulations. Working with statistical analysis from each student upward, gives us the opportunity to measure student's level and progress and to scale up to state statistics and grade level statics by subject and by grade levels. Knowing where the limits for state performance levels are a must not an option. This method measures these statics in a real time week by week basis to make sure we stay on track, and maintain toward excellence in education.

### BRIEF DESCRIPTION OF THE DRAWINGS

Taking the following specifications in conjunction with the accompanying drawings will cause the invention to be better understood regarding these and other features and advantages. The specifications reference the annexed drawings wherein:

FIG. 1 is a flow chart describing the teaching method.

FIG. 2 is an exemplary set of student worksheets

FIG. 3 is an exemplary class report.

FIG. 4 are exemplary student performance reports.

### DETAILED DESCRIPTION OF THE PREFERRED EMBODIMENTS

While describing the invention and its embodiments, various terms will be used for the sake of clarity. These terms are intended to not only include the recited embodiments, but also all equivalents that perform substantially the same function, in substantially the same manner to achieve the same result.

For simplicity's sake we will describe the teaching method using specific mathematical tasks as an example, but this is not to be construed as a limitation. The term task is intended in its broadest sense of any activity that can be done or improved upon, not just traditional testing. This method could readily be applied to all other realms of education or behavioral modifications, such as grammar, foreign language, animal training, singing and music to name a few examples. In these other embodiments there would be modification on the transmission and reception of the signal or information to the student, but the general concept of repetitive analyses of input from the student and then correction thereof and redistributions is the same.

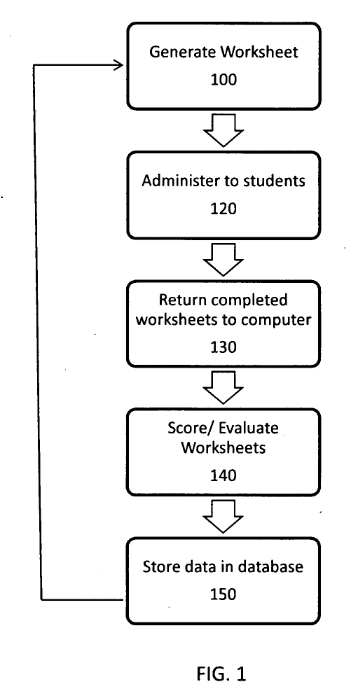

FIG. 1 is flow chart describing the teaching method at a very high level. The first stage in this educational process is the generation of a worksheet 100 which is then administered to the student 120 and on completion is re-introduced into the database 130 for scoring and evaluation 140 the results are then stored in the database 150 . This data is then analyzed and compared to the correct answer and then generates a worksheet 100 reflectant of the students performance. This information stored into the database is then used to generate various progress reports, general reports, letters, reward notices, emails, and parent notifications and store data. All of this data an these reports are to help the students progress or advance towards mastering the task they are trying to achieve.

The generation of a worksheet 100 requires various computer hardware and software which in a preferred embodiment would utilize a PC (personal computer) or similar device in conjunction with a database storage area to store and house the data generated and received from the student and the teachers. A standard printer would generate the worksheets. A means of converting the worksheets into computer readable data, such as a scanner would transform the data into a format such as PDF or a JPEGG. Finally a means of transferring the computer readable data to the PC would transfer the data via the internet or a web application, while a facsimile machine can also be used.

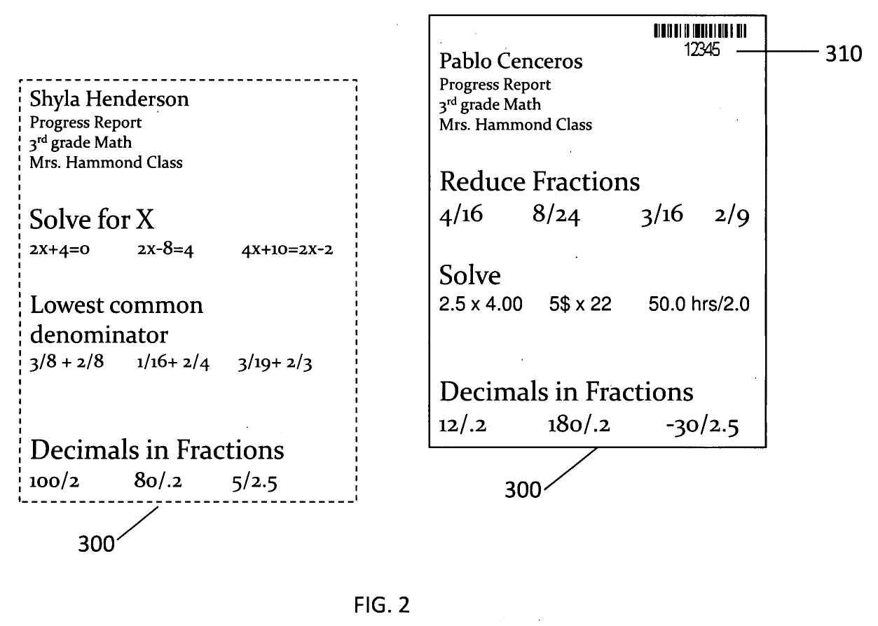

The preferred embodiment requires that the student receive a hardcopy or actual piece of paper to write on or worksheet, this makes the student able to perform his or her homework in an environment that does not have electricity or access to computer equipment. Embodiments of the worksheet this are illustrated in FIG. 2 and are generally depicted by the numeral 300. In order to return the worksheet 300 the student can either directly hand it to the teacher, mail it, or transmit it electronically through such means as faxing, scanning or other electronic transmission systems.

When an individual moves away from the classroom, the worksheets can be accessed from offsite. There are many reasons why a student may not attend class, for example vacation, sick leave, emergency leave, accidents, injury, changing schools, homelessness, foster care, detention, juvenile hall, or correctional facilities or instructional GED and proficiency equivalent centers that take up the high number of drop outs, but they will still have access to the educational system. In the event that a worksheet is lost, it can be accessed online via the web and the last worksheet can be re-printed again maintaining the learning protocol resuming exactly where the student left off. These worksheets can be used in conjunction with on line tutoring websites and Universities, local community tutoring at libraries, after school programs, YMCA or religious affiliated organizations utilizing these auto-generated worksheets outside the classroom, independently maintaining the progressions of worksheets.

In a preferred embodiment the worksheets 300 will have special encoding or possible a bar-code 310, in this event a special reader, such as a hand held bar code reader may be required. This encoding will match a barcode worksheet with a barcode answer key that was generated and stored with answers when the worksheet was first created. Although the student doesn't see the answers, the scanned barcode calls up the correct worksheet to print the answers on the worksheet itself, so that the students can see their mistakes. In another embodiment security measures are contemplated to preserve data integrity by remotely storing the data and protecting student data via biometrics

Generated worksheets address the learning style and pace of an individual. The random variables within the equation will generate different equations for each worksheet. Each worksheet is different and is designed based on the performance of the individual's strengths and weaknesses from previous scanned in worksheets. For example, math fractions maybe a weakness of one student and require more practice problems, while it can be the strength of another student which does not show fractions on the worksheet. Since all worksheets are different, copying work is not possible. The teacher does not generate the worksheets and is not giving the problems or challenging the student, so instead of the authoritarian adversary, they are seen as a person who can provide help and alliance.

The software is design to uses variables of random integers in equations not stored as databases, but in randomly chosen variables. This means that no worksheets will be identical. The off-the-shelf barcode design, and data storage, and barcode matching makes this process cost effective. The initial one-time executable programming cost can execute, direct and distribute massive amounts of data sets, across class, grade levels, schools, and multiple school districts, state and across the nation.

In one embodiment of the system the worksheet is divided into different sections or subject. In a math worksheet there could be three segments. Each segment addresses a different type of math equation, 5 equations per segment. Thus one worksheet has 15 equations, three different types. In order to get accurate statistics, the more worksheets graded are needed to establish statistical accuracy. (5 days, 5 equations=25 equations per segment in a week.) Segments change based on the performance. When 75% is accurately demonstrated, a new segment is replaced. It is possible to have two areas excel to new segments while keeping one segment unchanged until 75% accuracy is demonstrated. If a student remains in one segment for over 2 weeks, a flag is generated that alerts parents and the teacher that intervention is required. Students don't pass to the next grade without getting the help they need to understand the key elements. The math equations are derived from the grade level of example problems while the initial worksheet is derived from a student assessment tests required by the district testing. This ensures that the student is not only on par with his grade assessment, but also produces unique, custom tailored worksheets for the individual.

Completion of the worksheets is required, so that subsequent worksheets can be auto generated, tailored to specific needs. For example every, Monday 5 worksheets are generated. Ideally the student scans their document everyday to benefit in learning from the generated answers key. The barcode retrieves the matching answer key and prints the correct answer for benefit of learning. This is a student responsibility that requires no interaction from the teacher.

Evaluation of the data provided by the student's worksheets will identify those students who are spending too much time in one segment area, students who are not turning in assignments and those that are not progressing to the next level. These activities will generate flags. These flags are set up to introduce the matter to parents email, and or letters generated to the home. Making the parent or guardian aware of the problem is the first step, making suggestions or identifying tutorial support in the community will be the proof of burden on the parents. Thus the burden of poor performance is alerted to parents and students, to come up with a solution and identify how to solve the problems as they occur.

These flags can also be utilized to reward the student when performance is good or when certain objectives are reached, by generating coupons, award certificates or other motivational rewards.

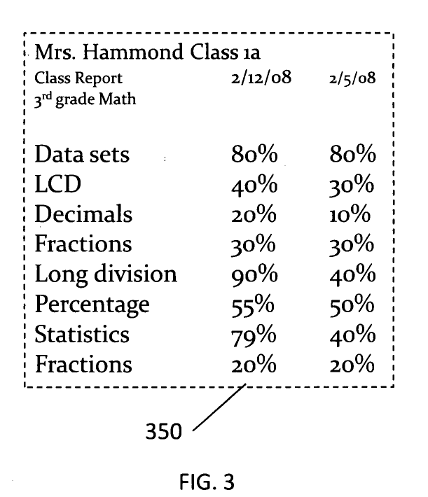

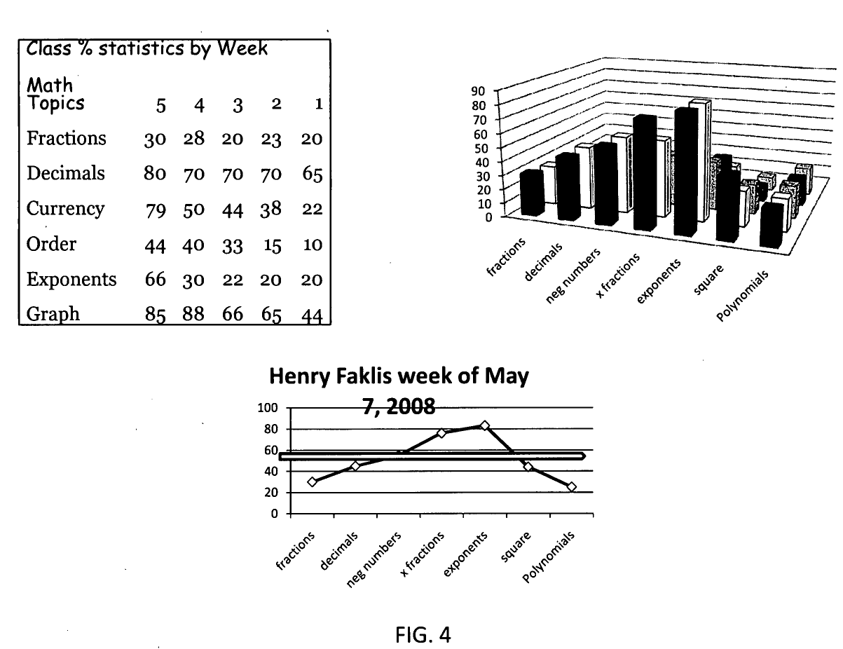

FIG. 3 and FIG. 4 are suggestions of various reporting formats to convey and convert the data analyzed from the worksheets into tangible reports, generally referred to as class reports 350. As well as analyzing the data on an individual by individual basis, the data is also assessed regarding the entire class. The Overall Class average gives a pictorial graph showing the lowest scores of the class by segment-topics. For example the scores that were low last week and are still low this week are in decimals and the same for the lowest common denominators. Using this data encourages the teacher try a different approach to the topic or re-explains, since the majority of the students are still facing the same challenges. The teacher can choose which lesson plan benefit the higher number of students based on the class overall report. For example, if five students are low in decimals, but 25 students are low in long division, the teacher would emphasize long division in her lectures. As scores change week to week, the teacher identifies which lecture topics will give greatest impact to the class. The creative judgment how best to respond to meet the demands of their students is what teachers do best. Emphasis should be made that a teachers greatest assets is to teach, as an educational system we should remove any extracurricular activities that diminishes any deviation that take away from this valuable assets.

The data received from the worksheets can be compiled into a student report that reveals a week by week performance, showing the progress at a glance. When low scores arise here, ideally the teacher can catch it early before the software generated flag. Observing this weekly report the teacher can see what the student is currently working on and where the lowest scores as indicators the needs of the child. During grading cycles, the teacher has several weeks of progress, with known values how many worksheets were turned in. This type of reporting helps the parents and students understand their responsibility toward improvement. At report card time, an auto-generated grade book can reflect student by progress

A weekly generated statistics report identifies areas of weakness and helps the teacher decide which instructional lesson plan would benefit the class potentially as a pictorial statistical analysis of where the majority of the class is faltering. In one embodiment this information empowers the teacher's effectiveness to choose topics that will serve the greatest need for the majority of the students. While not all students progress at the same rate, the software will generate individual worksheets addressing the outliers of the Gaussian bell shape curve, making sure all students are progressing. Outliers will continue to progress at their own level of challenge, without getting bored or frustrated, which commonly leads to discipline issues.

In one embodiment the scanned or faxed data has three dots located on the sheet that serve as reference points inside the all worksheets, invisible to the untrained eye. These three reference spots acts to orientate the worksheet in the correct position for grading, matching the barcode, and overlaying a answer key that can be directly printed onto the original worksheet, where by the masked areas could be saved in data sets and not require that the entire document get stored. Also having the correct answer printed onto the worksheets allows the student to learn from their mistakes and see how the correct answer is preformed. This is a powerful method of developing critical thinking skills—how to solve equations by proofs and gain personal proficiency.

Creating an environment where knowledge is power, our students can be aware of their power and their ability to make progress toward their education. Make the student responsible for how much work is needed to accomplish the goals of the current grade level. There are no hidden surprises, or futile efforts. When a child is constantly behind and always one step behind the curve it is easy to give up. We see a lot of school dropout when we don't address the need for educational support of struggling students. The student can see what is needed and take charge, combined that with encouraging gratifications of progress such as bowling coupons, movie passes, school supplies, and other private company sponsored donations. Rewards can be issued based on accelerated progress also flagged by software auto-generated ensures that students get recognized by their own merits of acceleration to allow those slower pace students to become winners too

These preferred embodiments are intended to illustrate the principles of the invention, but not to limit its scope. Variations and alternate embodiments will be apparent to those skilled in the art and may be made without departing from the spirit and scope of the invention defined by the following claims.

We claim:

1. An individualized educational system for improving learning efficiency by automatically generating, correcting and calibrating worksheets based on each individual student's learning progress and producing statistical reports base on such learning comprising:
a plurality of students; a computer system comprising computer software that creates a series of educational tasks that vary accordingly to the students performance printed onto a worksheet;
a plurality of unique and individualized worksheets, customized for each student relative to his or her performance on previous worksheets;
a means to convert said worksheets into computer readable format;
a means to transmit the computer readable data to the computer system; and
a means to evaluate students progress and generate statistical reports from said computer readable data.

2. The individualized educational system of claim 1 wherein said computer system utilizes a pc or similar device.

3. The individualized educational system of claim 1 wherein said computer software generates flags when student progress is subpar that notifies the teacher and others by generating reports, emails, and letters.

4. The individualized educational system of claim 1 wherein said worksheet are identified by a barcode symbol.

5. The individualized educational system of claim 1 wherein said means to convert said worksheets is a scanning device.

6. The individualized educational system of claim 1 wherein said means to evaluate students progress and generate statistical reports is computer software.

7. The individualized educational system of claim 1 wherein said computer readable data is secured by biometrics.

8. An educational system for improving learning efficiency automatically comprising:
distributing a plurality of tasks to students;
evaluating the students' task performance against correct responses;
creating and distributing a new series of tasks for the students to perform modified by performance on previous tasks;
evaluating each student's performance against a set standard to determine if more tasks are required or new ones can be introduced; and
analyzing and storing task results to generate progress reports.

9. The education system of claim 8 wherein said plurality of tasks are mathematic equations.

10. The education system of claim 8 wherein a computer creates, distributes,evaluates, analyzes and stores task results.
